(19) United States
(12) Patent Application Publication
(10) Pub. No.: US 2015/0042641 A1
(43) Pub. Date: Feb. 12, 2015

(54) TECHNIQUES TO AUTOMATICALLY ADJUST 3D GRAPHICS APPLICATION SETTINGS

(71) Applicants: TRAVIS T. SCHLUESSLER, HILLSBORO, OR (US); BRENT E. INSKO, PORTLAND, OR (US)

(72) Inventors: TRAVIS T. SCHLUESSLER, HILLSBORO, OR (US); BRENT E. INSKO, PORTLAND, OR (US)

(21) Appl. No.: 13/965,084

(22) Filed: Aug. 12, 2013

(51) Int. Cl. G06T 15/00

(52) U.S. Cl. CPC G06T 15/005
USPC 345/419

(57) ABSTRACT

Techniques for automatically adjusting three-dimensional (3D) graphics application settings are described. In one embodiment, for example, an apparatus may comprise a processor circuit to execute a 3D graphics application based on one or more feature control settings and a 3D graphics management module to determine a performance metric during execution of the 3D graphics application, compare the performance metric to a performance threshold, and when the performance metric is less than the performance threshold, determine a set of one or more setting adjustments based on feature control information to increase a performance of the 3D graphics application. Other embodiments are described and claimed.

### BACKGROUND

The performance of a three-dimensional (3D) graphics application, as well as the quality of visual effects produced by the application, may depend on a variety of settings that control various features impacting 3D graphics processing and/or presentation. Often, the determination of such settings involves evaluating a tradeoff between application performance and visual quality. Settings that strictly maximize the quality of the presented visual effects may yield undesirably slow performance, while settings that strictly maximize performance may unnecessarily sacrifice quality in order to obtain performance gains that are of little or no marginal benefit. Identifying desirable settings may involve, for example, determining settings that yield a highest level of quality while maintaining performance within an optimal range, or determining settings that yield a highest level of performance while maintaining quality within an optimal range. According to conventional techniques, user intervention may be required in order to specify feature control settings, and users may be forced to employ trial and error in order to determine settings that produce acceptable combinations of performance and quality.

### BRIEF DESCRIPTION OF THE DRAWINGS

FIG. 1 illustrates one embodiment of an apparatus and one embodiment of a first system.

FIG. 2 illustrates one embodiment of a feature control table.

FIG. 3 illustrates one embodiment of a logic flow.

FIG. 4 illustrates one embodiment of a storage medium.

FIG. 5 illustrates one embodiment of a second system.

FIG. 6 illustrates one embodiment of a third system.

FIG. 7 illustrates one embodiment of a device.

### DETAILED DESCRIPTION

Various embodiments are generally directed to techniques for automatically adjusting three-dimensional (3D) graphics application settings. More particularly, some embodiments are generally directed to techniques for automatically adjusting 3D graphics application settings such that acceptable levels of performance and quality are maintained. In one embodiment, for example, an apparatus may comprise a processor circuit to execute a 3D graphics application based on one or more feature control settings and a 3D graphics management module to determine a performance metric during execution of the 3D graphics application, compare the performance metric to a performance threshold, and when the performance metric is less than the performance threshold, determine a set of one or more setting adjustments based on feature control information to increase a performance of the 3D graphics application. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

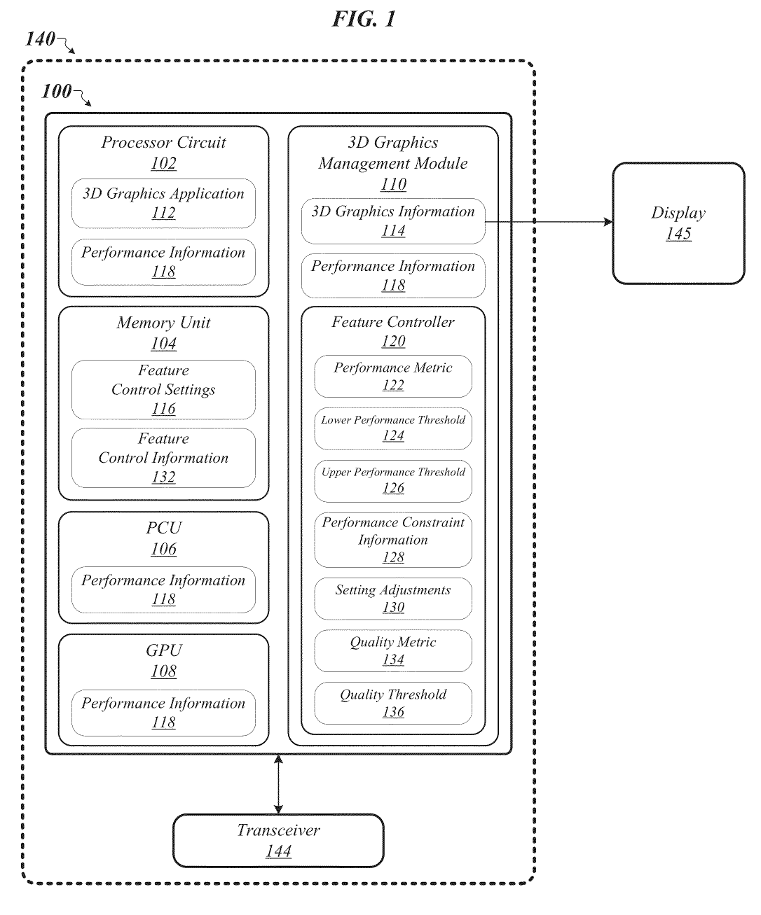

FIG. 1 illustrates a block diagram of an apparatus 100. As shown in FIG. 1, apparatus 100 comprises multiple elements including a processor circuit 102, a memory unit 104, a power control unit (PCU) 106, a graphics processing unit (GPU) 108, and a 3D graphics management module 110. The embodiments, however, are not limited to the type, number, or arrangement of elements shown in this figure.

In various embodiments, apparatus 100 may comprise processor circuit 102. Processor circuit 102 may be implemented using any processor or logic device, such as a complex instruction set computer (CISC) microprocessor, a reduced instruction set computing (RISC) microprocessor, a very long instruction word (VLIW) microprocessor, an x86 instruction set compatible processor, a processor implementing a combination of instruction sets, a multi-core processor such as a dual-core processor or dual-core mobile processor, or any other microprocessor or central processing unit (CPU). Processor circuit 102 may also be implemented as a dedicated processor, such as a controller, a microcontroller, an embedded processor, a chip multiprocessor (CMP), a co-processor, a digital signal processor (DSP), a network processor, a media processor, an input/output (I/O) processor, a media access control (MAC) processor, a radio baseband processor, an application specific integrated circuit (ASIC), a field programmable gate array (FPGA), a programmable logic device (PLD), and so forth. In one embodiment, for example, processor circuit 102 may be implemented as a general purpose processor, such as a processor made by Intel® Corporation, Santa Clara, Calif. The embodiments are not limited in this context.

In some embodiments, apparatus 100 may comprise or be arranged to communicatively couple with a memory unit 104. Memory unit 104 may be implemented using any machine-readable or computer-readable media capable of storing data, including both volatile and non-volatile memory. For example, memory unit 104 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy of note that some portion or all of memory unit 104 may be included on the same integrated circuit as processor circuit 102, or alternatively some portion or all of memory unit 104 may be disposed on an integrated circuit or other medium, for example a hard disk drive, that is external to the integrated circuit of processor circuit 102. Although memory unit 104 is comprised within apparatus 100 in FIG. 1, memory unit 104 may be external to apparatus 100 in some embodiments. The embodiments are not limited in this context.

In various embodiments, apparatus 100 may comprise a power control unit (PCU) 106. PCU 106 may comprise logic, circuitry, and/or instructions operative to monitor and/or manage power consumption on the part of apparatus 100 and/or various components therein. In some embodiments, PCU 106 may comprise circuitry within processor circuit 102, while in various other embodiments, PCU 106 may comprise stand-alone power control and monitoring circuitry. In some embodiments, PCU 106 may comprise one or more sensors operative to measure temperature, current, power, and/or other parameters at one or more locations within apparatus 100. The embodiments are not limited in this context.

In various embodiments, apparatus 100 may comprise a graphics processing unit (GPU) 108. GPU 108 may comprise a processor or logic device dedicated to the processing of graphics information. In some embodiments, GPU 108 may comprise a graphics chip designed for graphics processing, while in various other embodiments, GPU 108 may comprise a general purpose processor circuit, chip, or core utilized for processing graphics information. In some embodiments, GPU 108 may comprise an integrated graphics processing chip or circuitry disposed on a same integrated circuit or printed circuit board as processor circuit 102. In various other embodiments, GPU 108 may be disposed on a graphics card or other peripheral communicatively coupled to processor circuit 102. The embodiments are not limited in this context.

In some embodiments, apparatus 100 may comprise a 3D graphics management module 110. 3D graphics management module 110 may comprise logic, circuitry, and/or instructions operative to process information, logic, or data received from processor circuit 102, memory unit 104, GPU 108, and/or one or more elements external to apparatus 100, and to generate 3D graphics information 114 based on the received information, logic, or data. 3D graphics information 114 may comprise logic, data, information, and/or instructions operative on one or more displays, to cause presentation of one or more 3D visual effects. In various embodiments, graphics management module 110 may comprise a device driver for GPU 108. In some embodiments, processor circuit 102 may be operative to execute a 3D graphics application 112, and 3D graphics management module 110 may be operative to generate 3D graphics information 114 based on instructions generated by 3D graphics application 112. In an example embodiment, 3D graphics application 112 may comprise a 3D video playback application, and may instruct 3D graphics management module 110 to generate 3D graphics information 114 operative to cause a 3D video to be presented on a display. The embodiments are not limited to these examples.

FIG. 1 also illustrates a block diagram of a system 140. System 140 may comprise any of the aforementioned elements of apparatus 100. System 140 may further comprise a transceiver 144. Transceiver 144 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, transceiver 144 may operate in accordance with one or more applicable standards in any version. The embodiments are not limited in this context.

In various embodiments, apparatus 100 and/or system 140 may be communicatively coupled to a display 145. Display 145 may comprise any display device capable of presenting 3D visual effects based on 3D graphics information 114 received from apparatus 100 and/or system 140. Examples for display 145 may include a television, a monitor, a projector, and a computer screen. In one embodiment, for example, display 145 may be implemented by a liquid crystal display (LCD) display, light emitting diode (LED) display, or other type of suitable visual interface. Display 145 may comprise, for example, a touch-sensitive color display screen. In various implementations, display 145 may comprise one or more thin-film transistors (TFT) LCDs including embedded transistors. In some embodiments, display 145 may comprise a stereoscopic 3D display, a holographic display, or another type of 3D display. The embodiments are not limited in this context.

In general operation, apparatus 100 and/or system 140 may be operative to execute 3D graphics application 112 and to transmit 3D graphics information 114 generated during execution of 3D graphics application 112 to display 145. In some embodiments, apparatus 100 and/or system 140 may be operative to execute 3D graphics application 112 and to generate 3D graphics information 114 based on setting values for one or more graphics features associated with characteristics of 3D visual effects presented on display 145. For example, apparatus 100 and/or system 140 may be operative to execute 3D graphics application 112 and to generate 3D graphics information 114 based on setting values for graphics features such as antialiasing, anisotropic filtering, display resolution, shader complexity, shadow effects, and/or other features. In some embodiments, the values utilized for such graphics features may affect the performance of 3D graphics application 112 and/or 3D graphics management module 110, and/or may affect the quality of 3D visual effects presented on display 145. In various embodiments, during execution of 3D graphics application 112, apparatus 100 and/or system 140 may be operative to automatically adjust one or more feature control settings in order to maintain acceptable levels of performance and quality. The embodiments are not limited in this context.

In various embodiments, as noted above, processor circuit 102 may be operative to execute 3D graphics application 112. In some embodiments, processor circuit 102 may be operative to commence execution of 3D graphics application 112 using initial values for feature control settings 116. The initial values for feature control settings 116 may comprise initial setting values for various graphics features such as antialiasing, anisotropic filtering, display resolution, shader complexity, shadow effects, and/or other features. In various embodiments, the initial values for feature control settings 116 may include initial setting values for application-specific graphics features. Application-specific graphics features may comprise graphics features that are defined within 3D graphics application 112 and pertain specifically to 3D visual effects associated with 3D graphics application 112. For example, in one embodiment, 3D graphics application 112 may define a “rain” visual effect, and the initial values for feature control settings 116 may include an initial setting value for the rain effect. In some embodiments, the initial values for feature control settings 116 may additionally or alternatively include initial setting values for global graphics features. Global graphics features may comprise graphics features that are defined outside of 3D graphics application 112, such as by a graphics driver or operating system. For example, in one embodiment, a graphics driver may define an antialiasing effect that any 3D graphics application 112 may reference, and the initial values for feature control settings 116 may include an initial setting value for the antialiasing effect. The embodiments are not limited to these examples.

In various embodiments, one or more components of apparatus 100 and/or system 140 may be operative to generate performance information 118 during execution of 3D graphics application 112. Performance information 118 may comprise information describing the performance of various operations in the 3D graphics pipeline by various components of apparatus 100 and/or system 140. For example, performance information 118 may comprise information describing the speed, efficiency, utilization levels, and/or power consumption associated with the performance of tasks in the 3D graphics pipeline at processor circuit 102, memory unit 104, GPU 108, and/or 3D graphics management module 110. The embodiments are not limited in this context.

In some embodiments, 3D graphics management module 110 may comprise feature controller 120. Feature controller 120 may comprise logic, circuitry, and/or instructions operative to monitor performance information 118 during execution of 3D graphics application 112 and to dynamically adjust one or more feature control settings based on performance information 118. In various embodiments, during execution of 3D graphics application 112, portions of performance information 118 may be received from processor circuit 102, memory unit 104, PCU 106, and/or GPU 108, and portions of performance information 118 may also be generated internally by 3D graphics management module 110. In some embodiments, when processor circuit 102 commences execution of 3D graphics application 112, feature controller 120 may be operative to determine whether to perform dynamic adjustment of feature control settings based on a parameter indicating whether dynamic feature control is enabled. For example, if a dynamic feature control parameter indicates that dynamic feature control is disabled for 3D graphics application 112, feature controller 120 may abstain from performing dynamic feature control during execution of 3D graphics application 112, while feature controller 120 may perform dynamic feature control during execution of 3D graphics application 112 if the dynamic feature control parameter indicates that dynamic feature control is enabled. The embodiments are not limited in this context.

In various embodiments, feature controller 120 may be operative to generate performance metric 122 based on performance information 118. Performance metric 122 may comprise a value indicating an overall speed, efficiency, or throughput of the process of generating 3D graphics information 114 for transmission to display 145. For example, in some embodiments, performance metric 122 may comprise a generated frame rate of 3D video generated for transmission to display 145 as 3D graphics information 114. In various such embodiments, the generated frame rate may comprise an average rate of frame generation over a particular preceding time period. In a particular example, performance metric 122 may comprise an average generated frame rate for a preceding ten second duration. The embodiments are not limited to these examples.

In some embodiments, feature controller 120 may be operative to compare performance metric 122 to one or more performance thresholds comprising threshold values used to determine whether the current performance realized by apparatus 100 and/or system 140 in executing 3D graphics application 112, generating 3D graphics information 114, and/or transmitting 3D graphics information 114 to display 145 is in an optimal range. More particularly, feature controller 120 may be operative to compare performance metric 122 to a lower performance threshold 124 and/or to an upper performance threshold 126. When performance metric 122 is below lower performance threshold 124, feature controller 120 may be operative to determine that the visual quality associated with 3D graphics information 114 should be decreased in order to improve performance. When performance metric 122 is above upper performance threshold 126, feature controller 120 may be operative to determine that performance is unnecessarily high and that performance may be decreased and visual quality increased. When performance metric 122 is in the range between lower performance threshold 124 and upper performance threshold 126, feature controller 120 may be operative to determine that performance is in an optimal range and that setting adjustments are not needed.

In an example embodiment, performance metric 122 may comprise a generated frame rate for 3D graphics information 114 comprising a video stream, and lower performance threshold 124 may comprise a video frame rate, such as 30 fps, below which viewing the video stream becomes uncomfortable and/or below which a user viewing experience is otherwise negatively impacted. If feature controller 120 determines that the generated frame rate is below the lower performance threshold 124, it may determine that performance should be increased such that the generated frame rate increases and negative effects on the user viewing experience are avoided.

In the same example embodiment, upper performance threshold 126 may comprise a refresh rate of display 145. If the generated frame rate is above the refresh rate of display 145, this may indicate that 3D graphics information 114 is being transmitted to display 145 faster than display 145 can display it. In turn, this may indicate that performance is needlessly high, and that excess performance may be sacrificed in order to improve the quality of the video stream as presented on display 145. Under such circumstances, feature controller 120 may be operative to determine that performance may be decreased such that the generated frame rate decreases. On the other hand, if the generated frame rate is between the lower performance threshold 124 and the upper performance threshold 126 in this example embodiment, feature controller 120 may be operative to determine that the video is streaming at a frame rate that is suitable for comfortable viewing and that the display 145 can handle, and thus may determine that no change in performance is necessary. The embodiments are not limited to these examples.

In various embodiments, when it has determined that performance metric 122 is below lower performance threshold 124, feature controller 120 may be operative to determine performance constraint information 128. Performance constraint information 128 may comprise information identifying components and/or sub-components of apparatus 100 and/or system 140 that are performance bottlenecks or otherwise negatively affect and/or constrain performance as measured by performance metric 122. For example, in an embodiment in which performance metric 122 comprises a generated frame rate, performance constraint information 128 may identify GPU 108 as a performance bottleneck if operations performed within GPU 108 are hindering the generated frame rate. Alternatively or additionally, in such an example embodiment, performance constraint information 128 may identify one or more sub-components of GPU 108 as performance bottlenecks. For example, performance constraint information 128 may identify sampler circuitry within GPU 108 as a performance bottleneck if operations performed within the sampler circuitry in particular are hindering the generated frame rate. The embodiments are not limited to these examples.

In some embodiments, feature controller 120 may be operative to determine one or more setting adjustments 130. In various embodiments, setting adjustments 130 may comprise modifications to one or more feature control settings 116. For example, in some embodiments, setting adjustments 130 may comprise modifications to feature control settings 116 relating to antialiasing, anisotropic filtering, display resolution, shader complexity, shadow effects, and/or other features. The embodiments are not limited to these examples.

In various embodiments, feature controller 120 may be operative to determine one or more setting adjustments 130 based on feature control information 132. Feature control information 132 may comprise information indicating previous and/or expected performance impacts of modifications to various feature control settings. For example, particular feature control information 132 may indicate that changing an anisotropic filtering setting from “4x” to “2x” is expected to result in a five percent increase in frame rate. Additionally or alternatively, feature control information 132 may comprise information indicating previous and/or expected performance levels associated with various combinations of feature control settings. For example, particular feature control information 132 may indicate that a particular combination of feature control settings 116 is expected to result in a generated frame rate of 56 fps. The embodiments are not limited in this context.

In some embodiments, a quality function may be defined in order to quantify the quality levels associated with various feature control settings. In various embodiments, according to such a quality function, an overall quality measure for a particular combination of settings may be calculated as a sum or other function of component quality values for the various setting in the combination. In some such embodiments, a change to a particular setting may be regarded as resulting in a change in visual quality equal to the difference between the component quality value for the old setting and the component quality value for the new setting. In various embodiments, the component quality values may comprise quantities specified by a device manufacturer, such as a graphics card or display manufacturer. In some other embodiments, the component quality values may comprise quantities specified by a developer of 3D graphics application 112. In various other embodiments, the component quality values may be obtained using a quality calibration sequence, during which a user provides feedback regarding the apparent visual quality of a series of images or other visual effects, and the component quality values are customized based on the user feedback. The embodiments are not limited in this context.

In some embodiments, feature control information 132 may comprise information indicating previous and/or expected quality impacts of modifications to various feature control settings based on such a quality function. For example, particular feature control information 132 may indicate that changing the anisotropic filtering setting from “4x” to “2x” is expected to result in a three percent decrease in quality according to the quality function. Additionally or alternatively, feature control information 132 may comprise information indicating previous and/or expected quality levels associated with various combinations of feature control settings, as defined by such a quality function. For example, particular feature control information 132 may indicate that a particular combination of feature control settings 116 is expected to result in a particular level of quality according to the quality function. The embodiments are not limited in this context.

In various embodiments, when it has determined that performance metric 122 is less than lower performance threshold 124, feature controller 120 may be operative to determine one or more setting adjustments 130 based on feature control information 132 and performance constraint information 128. More particularly, feature controller 120 may be operative to use performance constraint information 128 to determine one or more components and/or sub-components that comprise performance bottlenecks, and to use feature control information 132 to determine one or more setting adjustments 130 that are known or expected to help relieve bottlenecks at such components and/or sub-components. The embodiments are not limited in this context.

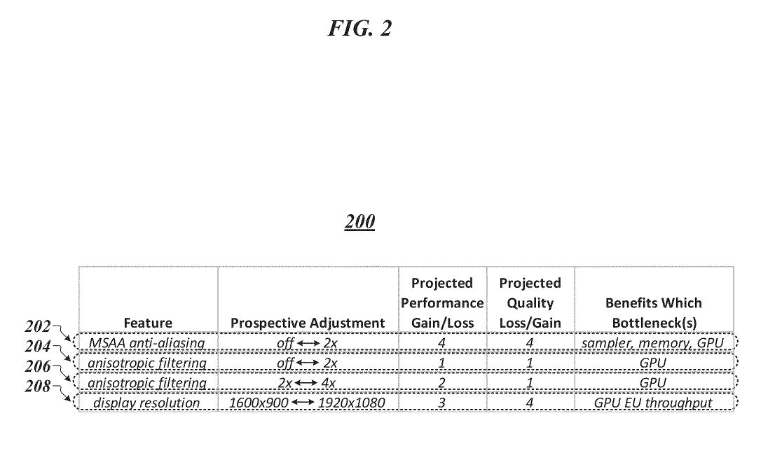

FIG. 2 illustrates a feature control table 200 such as may comprise an example of feature control information 132 of FIG. 1. As shown in FIG. 2, feature control table 200 comprises entries 202, 204, 206, and 208. Each of these entries identifies a particular 3D graphics processing feature, a prospective adjustment to that feature, the projected effects on performance and quality of the prospective adjustment, and component and/or sub-component processing bottlenecks that may be benefited by the prospective adjustment. For example, entry 202 indicates that adjusting a multi-sample anti-aliasing (MSAA) setting between “off” and “2x” is expected to result in a tradeoff of 4 units of performance for 4 units of quality, and may be suitable to address performance bottlenecks at the sampler, memory, or GPU.

It is worthy of note that no particular units are specified for the performance and quality gains/losses in feature control table 200 because the particular units used may vary from implementation to implementation, based on design choices. For example, in one implementation, the projected performance gain/loss could be expressed in units of frames per second, while in another implementation, the projected performance gain/loss could be expressed in units comprising percentages of a base performance value determined according to a defined performance function. Furthermore, the units of projected performance gain/loss need not necessarily be the same as the units of projected quality loss/gain. For example, the projected performance gain/loss could be expressed in units of frames per second, while the projected quality loss/gain could be expressed in units comprising percentages of a base quality value determined according to a defined quality function. The embodiments are not limited in this context.

It is also worthy of note that although FIG. 2 illustrates a feature control table comprising only four entries in the interest of simplicity, the embodiments are not limited in this context. Embodiments are both possible and contemplated in which feature control table 200 comprises a lesser or greater number of entries. Furthermore, the information comprised in feature control information 132 of FIG. 1 need not necessarily be in the form of a table as in the example of FIG. 2, but rather may take the form of any suitable data structure. The embodiments are not limited in this context.

In various embodiments, particular items of information in feature control information 132 of FIG. 1 and/or feature control table 200 of FIG. 2 may be combinable in order to obtain additional information regarding previous and/or expected results of various setting adjustments. For example, in feature control table 200 of FIG. 2, entries 204 and 206 both pertain to an anisotropic filtering feature, and both indicate that modifying an anisotropic filtering setting may benefit a bottleneck at the GPU. Entry 204 indicates that adjusting the anisotropic filtering setting between “off” and “2x” is expected to result in a tradeoff of 1 unit of performance for 1 unit of quality. Entry 206 indicates that adjusting the anisotropic filtering setting between “2x” and “4x” is expected to result in a tradeoff of 2 units of performance for 1 unit of quality. Based on these two entries, it may be possible to determine the expected results of adjusting the anisotropic filtering setting between “off” and “4x.” For example, if the projected performance gains/losses are expressed in frames per second, and the projected quality losses/gains are expressed in percentages of a base quality value determined according to a defined quality function, feature controller 120 of FIG. 1 may be operative to determine based on entries 204 and 206 that adjusting the anisotropic filtering setting between “off” and “4x” is expected to result in a tradeoff of 3 fps of generated frame rate for 2 units of 3D video quality. The embodiments are not limited to this example.

Entry 208 in feature control table 200 comprises an example of an entry that suggests a setting adjustment potentially suitable for addressing a graphics processing sub-component bottleneck. More particularly, while entries 204 and 206 indicate that adjusting the anisotropic filtering setting may benefit a bottleneck at the GPU in general, entry 208 indicates that adjusting the display resolution may benefit a bottleneck caused particularly by throughput limitations at the GPU execution units (EUs). If feature controller 120 of FIG. 1 knows, based on performance constraint information 128, that a bottleneck exists at the GPU EUs, it may determine based on entry 208 that adjusting the display resolution may be an appropriate setting adjustment. On the other hand, if it knows that the bottleneck exists at a different GPU sub-component, or if it knows only that the GPU in general is a bottleneck, feature controller 120 may determine based on entries 202, 204, and/or 206 that adjusting the MSAA anti-aliasing and/or anisotropic filtering settings may be more appropriate setting adjustments. The embodiments are not limited in this context.

Returning to FIG. 1, in some embodiments, when feature controller 120 has determined that performance metric 122 is less than lower performance threshold 124, it may be operative to determine one or more setting adjustments 130 that are expected to provide the most desirable tradeoffs of increased performance for decreased quality. In various embodiments, these may comprise setting adjustments that yield performance improvement sufficient to enter the optimal range at the lowest cost in terms of quality. In some embodiments, these may additionally or alternatively comprise setting adjustments that yield the highest ratios of performance improvement to quality loss. It is to be understood that the approaches used to evaluate and/or quantify the desirability of performance-quality tradeoffs may vary from implementation to implementation, and the embodiments are not limited in this context.

In an example embodiment, feature controller 120 may determine that performance metric 122 is less than lower performance threshold 124 by 3 units, and may consult feature control table 200 of FIG. 2 in order to identify prospective setting adjustments to increase performance. In this example embodiment, the current feature control settings 116 may comprise an MSAA anti-aliasing setting of “2x” and an anisotropic filtering setting of “4x.” Based on these current feature control settings 116 and the information in feature control table 200, feature controller 120 may identify both the MSAA anti-aliasing setting and the anisotropic filtering setting as settings that may be adjusted in order to obtain the desired 3 unit increase in performance. More particularly, feature controller 120 may determine that changing the MSAA anti-aliasing setting from “2x” to “off” is expected to yield a 4 unit performance increase at a cost of 4 quality units, and may determine that changing the anisotropic filtering setting from “4x” to “off” is expected to yield a 3 unit performance increase at a cost of 2 quality units. Since the latter setting adjustment still results in performance entering the optimal range yet causes half as much quality reduction as the former setting adjustment, feature controller 120 may select the anisotropic filtering adjustment as a setting adjustment 130. The embodiments are not limited to this example.

In some embodiments, when feature controller 120 has determined that performance metric 122 is greater than upper performance threshold 126, it may be operative to determine one or more setting adjustments 130 that are expected to provide the most desirable tradeoffs of increased quality for decreased performance. In various embodiments, these may comprise setting adjustments that yield the highest ratios of quality improvement to performance reduction, and that are expected to result in performance entering the optimal range. As noted above, the approaches used to evaluate and/or quantify the desirability of performance-quality tradeoffs may vary from implementation to implementation, and the embodiments are not limited in this context.

In an example embodiment, feature controller 120 may determine that performance metric 122 is greater than upper performance threshold 126 by 3 units, and may consult feature control table 200 of FIG. 2 in order to identify prospective setting adjustments to increase quality at the expense of performance. In this example embodiment, the current feature control settings 116 may comprise an MSAA anti-aliasing setting of “off” and an anisotropic filtering setting of “off.” Based on these current feature control settings 116 and the information in feature control table 200, feature controller 120 may identify both the MSAA anti-aliasing setting and the anisotropic filtering setting as settings that may be adjusted in order to increase quality while reducing performance by at least 3 units. More particularly, feature controller 120 may determine that changing the MSAA anti-aliasing setting from “off” to “2x” is expected to yield a 4 unit quality increase at a cost of 4 performance units, and may determine that changing the anisotropic filtering setting from “off” to “4x” is expected to yield a 2 unit quality increase at a cost of 3 performance units. Since both setting adjustments result in performance entering the optimal range, yet the former adjustment yields twice as much quality improvement as the latter, feature controller 120 may select the MSAA anti-aliasing adjustment as a setting adjustment 130. Alternatively, depending on the implementation and the value of lower performance threshold 124, feature controller 120 may select both the MSAA anti-aliasing adjustment and the anisotropic filtering adjustment as setting adjustments 130, in order to obtain an overall 6 unit increase in quality. The embodiments are not limited to this example.

In some embodiments, rather than basing the determination of whether to adjust feature control settings 116 simply on performance, feature controller 120 may alternatively or additionally be operative to determine whether to adjust feature control settings 116 based on quality. For example, in various embodiments, feature controller 120 may be operative to generate a quality metric 134 based on feature control settings 116 using a quality function, and to compare the quality metric 134 to a quality threshold 136. In some such embodiments, if the quality metric 134 is less than the quality threshold 136, feature controller 120 may be operative to consult feature control information 132 to identify one or more setting adjustments 130 that are expected to result in a level of quality above the quality threshold at the lowest cost in terms of performance. In various other embodiments, feature controller 120 may base its decisions on both performance metric 122 and quality metric 134. For example, in some embodiments, feature controller 120 may be operative to determine one or more setting adjustments 130 that yield a performance level within the optimal range without reducing quality to a level below quality threshold 136. The embodiments are not limited in this context.

In various embodiments, once it has determined setting adjustments 130, feature controller 120 may apply them to modify feature control settings 116, and processor circuit 102 may then continue executing 3D graphics application 112 using the adjusted feature control settings 116. Feature controller 120 may then wait for a defined delay period before once again computing performance metric 122 and/or quality metric 134 and performing further adjustments to feature control settings 116 as appropriate. Such a delay period may be selected in order to limit an amount of time that suboptimal settings are allowed to persist, but also to prevent feature control settings 116 from being modified too rapidly in succession. The embodiments are not limited in this context.

In some embodiments, after waiting for the defined delay period and once again computing performance metric 122 and/or quality metric 134, feature controller 120 may be operative to update feature control information 132 based on the newly measured performance metric 122 and/or quality metric 134. For example, if the newly measured performance metric 122 indicates that modifications applied to feature control settings 116 did not increase performance as much as expected based on feature control information 132, feature controller 120 may be operative to update feature control information 132 in order to reduce the projected performance increases associated with one or more of the adjusted settings. The embodiments are not limited to this example.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

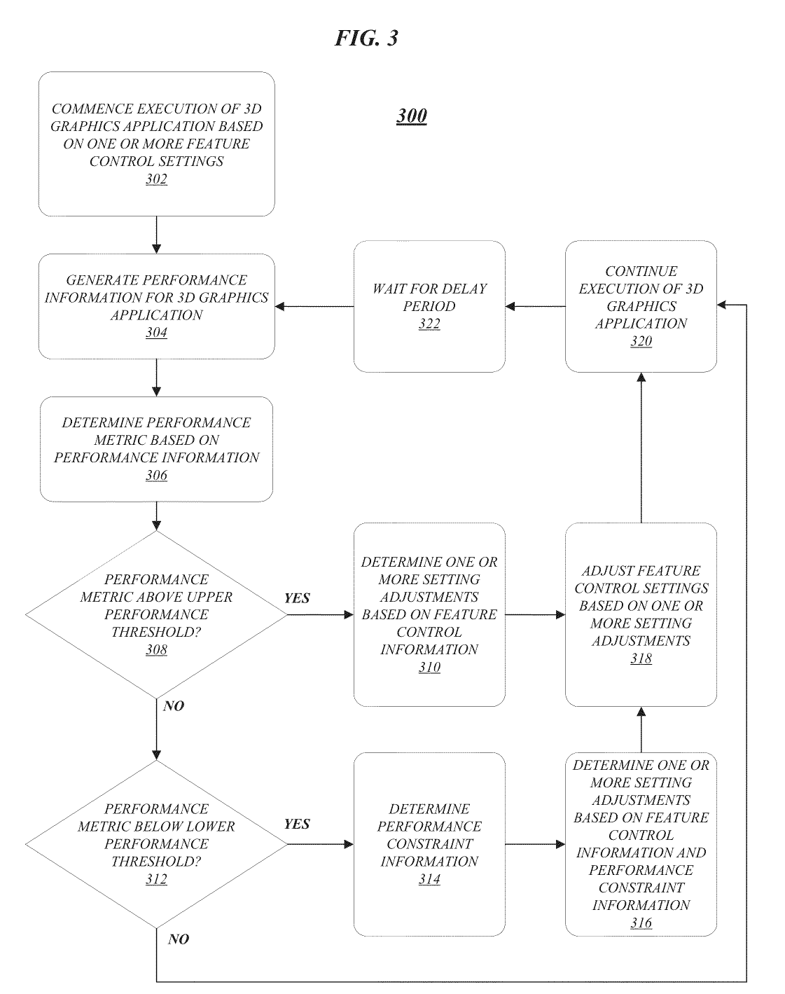

FIG. 3 illustrates one embodiment of a logic flow 300, which may be representative of the operations executed by one or more embodiments described herein. As shown in logic flow 300, execution of a 3D graphics application may be commenced at 302. For example, processor circuit 102 of FIG. 1 may be operative to commence execution of 3D graphics application 112. At 304, performance information may be generated for the 3D graphics application. For example, processor circuit 102, PCU 106, GPU 108, and/or 3D graphics management module 110 of FIG. 1 may be operative to generate performance information 118. At 306, a performance metric may be determined based on the performance information. For example, feature controller 120 of FIG. 1 may be operative to determine performance metric 122 based on performance information 118. At 308, it may be determined whether the performance metric is above a performance threshold. For example, feature controller 120 of FIG. 1 may be operative to determine whether performance metric 122 is greater than upper performance threshold 126. If it is determined at 308 that the performance metric is above the upper performance threshold, flow may pass to 310. At 310, one or more setting adjustments may be determined based on the feature control information. For example, feature controller 120 of FIG. 1 may be operative to determine one or more setting adjustments 130 based on feature control information 132 to increase the quality of 3D graphics information 114 while decreasing performance. Flow may then pass to 318.

If, at 308, it is determined that the performance metric is not above the upper performance threshold, flow may pass to 312. At 312, it may be determined whether the performance metric is below a lower performance threshold. For example, feature controller 120 of FIG. 1 may be operative to determine whether performance metric 122 is less than lower performance threshold 124. It is determined that the performance metric is not below the lower performance threshold, flow may pass to 320, where execution of the 3D graphics application may continue. If it is determined that the performance metric is below the lower performance threshold, flow may pass to 314. At 314, performance constraint information may be determined. For example, feature controller 120 of FIG. 1 may be operative to determine performance constraint information 128. At 316, one or more setting adjustments may be determined based on the feature control information and the performance constraint information. For example, feature controller 120 of FIG. 1 may be operative to determine one or more setting adjustments 130 based on feature control information 132 and performance constraint information 128 to increase performance while sacrificing the quality of 3D graphics information 114. Flow may then pass to 318.

At 318, the feature control settings may be adjusted based on the one or more setting adjustments. For example, feature controller 120 of FIG. 1 may be operative to adjust feature control settings 116 based on one or more setting adjustments 130. From 318, flow may pass to 320, where the execution of 3D graphics application may continue, and then to 322. At 322, a wait comprising a delay period may be performed before generating additional performance information and determining another performance metric. For example, feature controller 120 may be operative to wait a delay period before generating additional performance information 118 and determining another performance metric 122. The embodiments are not limited to these examples.

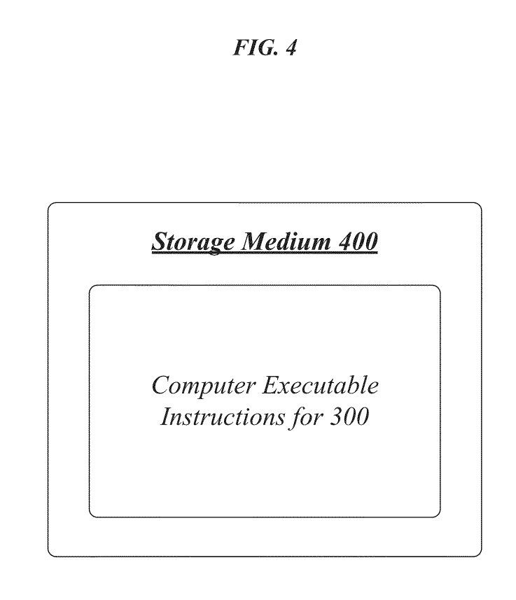

FIG. 4 illustrates an embodiment of a storage medium 400. The storage medium 400 may comprise an article of manufacture. In one embodiment, the storage medium 400 may comprise any non-transitory computer readable medium or machine readable medium, such as an optical, magnetic or semiconductor storage. The storage medium may store various types of computer executable instructions, such as instructions to implement logic flow 300. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The embodiments are not limited in this context.

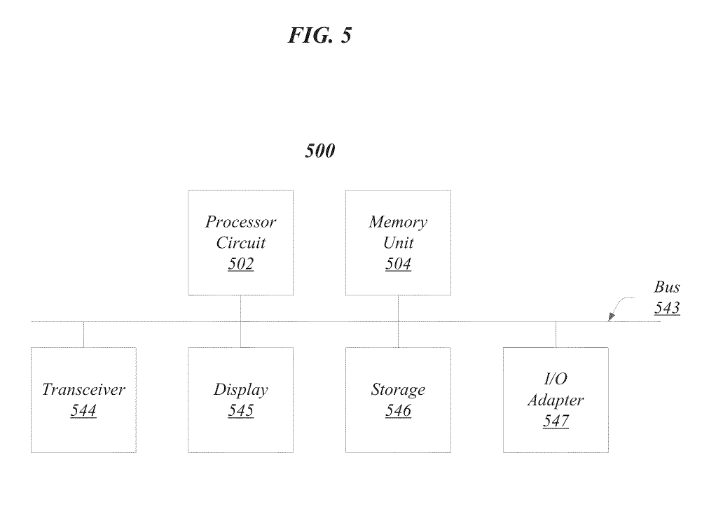

FIG. 5 illustrates one embodiment of a system 500. In various embodiments, system 500 may be representative of a system or architecture suitable for use with one or more embodiments described herein, such as apparatus 100 and/or system 140 of FIG. 1, logic flow 300 of FIG. 3, and/or storage medium 400 of FIG. 4. The embodiments are not limited in this respect.

As shown in FIG. 5, system 500 may include multiple elements. One or more elements may be implemented using one or more circuits, components, registers, processors, software subroutines, modules, or any combination thereof, as desired for a given set of design or performance constraints. Although FIG. 5 shows a limited number of elements in a certain topology by way of example, it can be appreciated that more or less elements in any suitable topology may be used in system 500 as desired for a given implementation. The embodiments are not limited in this context.

In various embodiments, system 500 may include a processor circuit 502. Processor circuit 502 may be implemented using any processor or logic device, and may be the same as or similar to processor circuit 102 of FIG. 1.

In one embodiment, system 500 may include a memory unit 504 to couple to processor circuit 502. Memory unit 504 may be coupled to processor circuit 502 via communications bus 543, or by a dedicated communications bus between processor circuit 502 and memory unit 504, as desired for a given implementation. Memory unit 504 may be implemented using any machine-readable or computer-readable media capable of storing data, including both volatile and non-volatile memory, and may be the same as or similar to memory unit 104 of FIG. 1. In some embodiments, the machine-readable or computer-readable medium may include a non-transitory medium. The embodiments are not limited in this context.

In various embodiments, system 500 may include a transceiver 544. Transceiver 544 may include one or more radios capable of transmitting and receiving signals using various suitable wireless communications techniques, and may be the same as or similar to transceiver 144 of FIG. 1.

In various embodiments, system 500 may include a display 545. Display 545 may comprise any display device capable of displaying information received from processor circuit 502, and may be the same as or similar to display 145 of FIG. 1. The embodiments are not limited in this context.

In various embodiments, system 500 may include storage 546. Storage 546 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 546 may include technology to increase the storage performance enhanced protection for valuable digital media when multiple hard drives are included, for example. Further examples of storage 546 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, system 500 may include one or more I/O adapters 547. Examples of I/O adapters 547 may include Universal Serial Bus (USB) ports/adapters, IEEE 1394 Firewire ports/adapters, and so forth. The embodiments are not limited in this context.

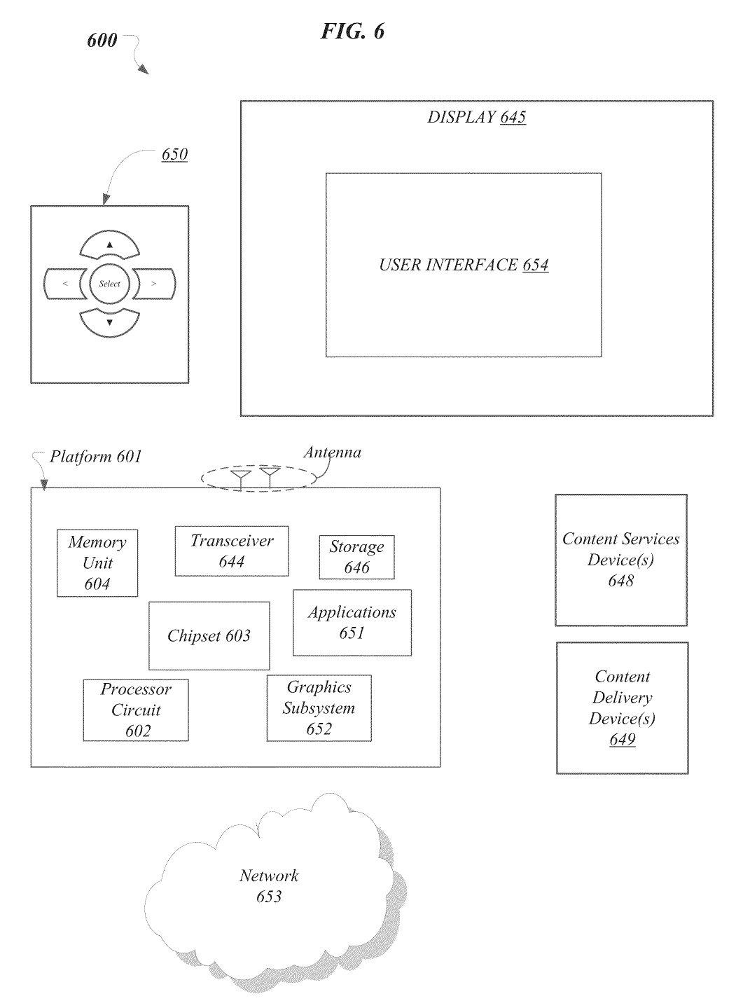

FIG. 6 illustrates an embodiment of a system 600. In various embodiments, system 600 may be representative of a system or architecture suitable for use with one or more embodiments described herein, such as apparatus 100 and/or system 140 of FIG. 1, logic flow 300 of FIG. 3, storage medium 400 of FIG. 4, and/or system 500 of FIG. 5. The embodiments are not limited in this respect.

As shown in FIG. 6, system 600 may include multiple elements. One or more elements may be implemented using one or more circuits, components, registers, processors, software subroutines, modules, or any combination thereof, as desired for a given set of design or performance constraints. Although FIG. 6 shows a limited number of elements in a certain topology by way of example, it can be appreciated that more or less elements in any suitable topology may be used in system 600 as desired for a given implementation. The embodiments are not limited in this context.

In embodiments, system 600 may be a media system although system 600 is not limited to this context. For example, system 600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 600 includes a platform 601 coupled to a display 645. Platform 601 may receive content from a content device such as content services device(s) 648 or content delivery device(s) 649 or other similar content sources. A navigation controller 650 including one or more navigation features may be used to interact with, for example, platform 601 and/or display 645. Each of these components is described in more detail below.

In embodiments, platform 601 may include any combination of a processor circuit 602, chipset 603, memory unit 604, transceiver 644, storage 646, applications 651, and/or graphics subsystem 652. Chipset 603 may provide intercommunication among processor circuit 602, memory unit 604, transceiver 644, storage 646, applications 651, and/or graphics subsystem 652. For example, chipset 603 may include a storage adapter (not depicted) capable of providing intercommunication with storage 646.

Processor circuit 602 may be implemented using any processor or logic device, and may be the same as or similar to processor circuit 502 in FIG. 5.

Memory unit 604 may be implemented using any machine-readable or computer-readable media capable of storing data, and may be the same as or similar to memory unit 504 in FIG. 5.

Transceiver 644 may include one or more radios capable of transmitting and receiving signals using various suitable wireless communications techniques, and may be the same as or similar to transceiver 544 in FIG. 5.

Display 645 may include any television type monitor or display, and may be the same as or similar to display 545 in FIG. 5.

Storage 646 may be implemented as a non-volatile storage device, and may be the same as or similar to storage 546 in FIG. 5.

Graphics subsystem 652 may perform processing of images such as still or video for display. Graphics subsystem 652 may be a graphics processing unit (GPU) or a visual processing unit (VPU), for example. An analog or digital interface may be used to communicatively couple graphics subsystem 652 and display 645. For example, the interface may be any of a High-Definition Multimedia Interface, DisplayPort, wireless HDMI, and/or wireless HD compliant techniques. Graphics subsystem 652 could be integrated into processor circuit 602 or chipset 603. Graphics subsystem 652 could be a stand-alone card communicatively coupled to chipset 603.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

In embodiments, content services device(s) 648 may be hosted by any national, international and/or independent service and thus accessible to platform 601 via the Internet, for example. Content services device(s) 648 may be coupled to platform 601 and/or to display 645. Platform 601 and/or content services device(s) 648 may be coupled to a network 653 to communicate (e.g., send and/or receive) media information to and from network 653. Content delivery device(s) 649 also may be coupled to platform 601 and/or to display 645.

In embodiments, content services device(s) 648 may include a cable television box, personal computer, network, telephone, Internet enabled devices or appliance capable of delivering digital information and/or content, and any other similar device capable of unidirectionally or bidirectionally communicating content between content providers and platform 601 and/display 645, via network 653 or directly. It will be appreciated that the content may be communicated unidirectionally and/or bidirectionally to and from any one of the components in system 600 and a content provider via network 653. Examples of content may include any media information including, for example, video, music, medical and gaming information, and so forth.

Content services device(s) 648 receives content such as cable television programming including media information, digital information, and/or other content. Examples of content providers may include any cable or satellite television or radio or Internet content providers. The provided examples are not meant to limit embodiments of the disclosed subject matter.

In embodiments, platform 601 may receive control signals from navigation controller 650 having one or more navigation features. The navigation features of navigation controller 650 may be used to interact with a user interface 654, for example. In embodiments, navigation controller 650 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 650 may be echoed on a display (e.g., display 645) by movements of a pointer, cursor, focus ring, or other visual indicators displayed on the display. For example, under the control of software applications 651, the navigation features located on navigation controller 650 may be mapped to virtual navigation features displayed on user interface 654. In embodiments, navigation controller 650 may not be a separate component but integrated into platform 601 and/or display 645. Embodiments, however, are not limited to the elements or in the context shown or described herein.

In embodiments, drivers (not shown) may include technology to enable users to instantly turn on and off platform 601 like a television with the touch of a button after initial boot-up, when enabled, for example. Program logic may allow platform 601 to stream content to media adaptors or other content services device(s) 648 or content delivery device(s) 649 when the platform is turned “off.” In addition, chip set 603 may include hardware and/or software support for 5.1 surround sound audio and/or high definition 7.1 surround sound audio, for example. Drivers may include a graphics driver for integrated graphics platforms. In embodiments, the graphics driver may include a peripheral component interconnect (PCI) Express graphics card.

In various embodiments, any one or more of the components shown in system 600 may be integrated. For example, platform 601 and content services device(s) 648 may be integrated, or platform 601 and content delivery device(s) 649 may be integrated, or platform 601, content services device(s) 648, and content delivery device(s) 649 may be integrated, for example. In various embodiments, platform 601 and display 645 may be an integrated unit. Display 645 and content service device(s) 648 may be integrated, or display 645 and content delivery device(s) 649 may be integrated, for example. These examples are not meant to limit the disclosed subject matter.

In various embodiments, system 600 may be implemented as a wireless system, a wired system, or a combination of both. When implemented as a wireless system, system 600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 600 may include components and interfaces suitable for communicating over wired communications media, such as I/O adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 601 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

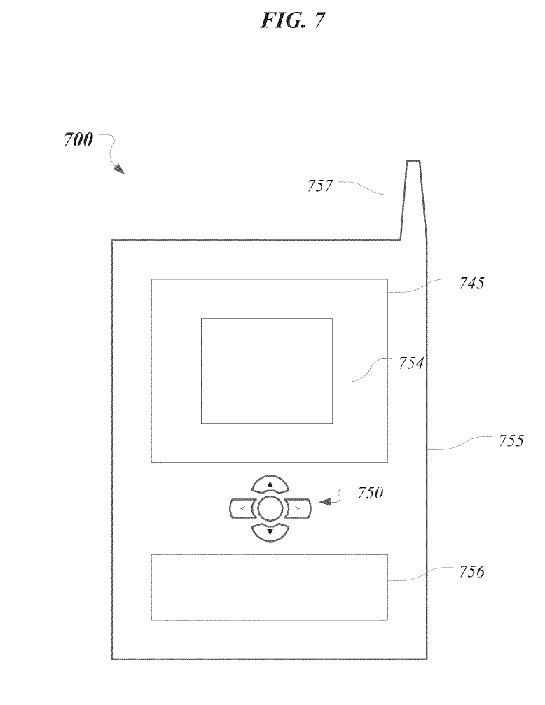

As described above, system 600 may be embodied in varying physical styles or form factors. FIG. 7 illustrates embodiments of a small form factor device 700 in which system 600 may be embodied. In embodiments, for example, device 700 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, device 700 may include a display 745, a navigation controller 750, a user interface 754, a housing 755, an I/O device 756, and an antenna 757. Display 745 may include any suitable display unit for displaying information appropriate for a mobile computing device, and may be the same as or similar to display 645 in FIG. 6. Navigation controller 750 may include one or more navigation features which may be used to interact with user interface 754, and may be the same as or similar to navigation controller 650 in FIG. 6. I/O device 756 may include any suitable I/O device for entering information into a mobile computing device. Examples for I/O device 756 may include an alphanumeric keyboard, a numeric keypad, a touch pad, input keys, buttons, switches, rocker switches, microphones, speakers, voice recognition device and software, and so forth. Information also may be entered into device 700 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine-readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments:

Example 1 is at least one machine-readable medium storing a set of graphics processing instructions that, in response to being executed on a computing device, cause the computing device to: commence execution of a three-dimensional (3D) graphics application based on one or more feature control settings; determine a performance metric during execution of the 3D graphics application; compare the performance metric to a performance threshold; and when the performance metric is less than the performance threshold, determine a set of one or more setting adjustments based on feature control information to increase a performance of the 3D graphics application.

In Example 2, the at least one machine-readable medium of Example 1 may optionally store instructions that, in response to being executed on the computing device, cause the computing device to, when the performance metric is less than the performance threshold: determine performance constraint information; and determine the one or more setting adjustments based on the feature control information and the performance constraint information.

In Example 3, the performance constraint information of Example 2 may optionally identify one or more components that comprise performance bottlenecks in a graphics processing system.

In Example 4, the at least one machine-readable medium of any one of Examples 1 to 3 may optionally store instructions that, in response to being executed on the computing device, cause the computing device to: compare the performance metric to a second performance threshold; and when the performance metric is greater than the second performance threshold, determine a second set of one or more setting adjustments based on the feature control information to increase a quality of 3D graphics information generated by the 3D graphics application.

In Example 5, the performance metric of any one of Examples 1 to 4 may optionally comprise a frame rate of video generated by the 3D graphics application.

In Example 6, the at least one machine-readable medium of any one of Examples 1 to 5 may optionally store instructions that, in response to being executed on the computing device, cause the computing device to adjust the one or more feature control settings during execution of the 3D graphics application based on the set of one or more setting adjustments.

In Example 7, the at least one machine-readable medium of Example 6 may optionally store instructions that, in response to being executed on the computing device, cause the computing device to: determine a second performance metric after adjusting the one or more feature control settings; and update the feature control information based on the second performance metric.

In Example 8, the at least one machine-readable medium of Example 7 may optionally store instructions that, in response to being executed on the computing device, cause the computing device to wait for a delay period after adjusting the one or more feature control settings before determining the second performance metric.

In Example 9, the feature control information of any one of Examples 1 to 8 may optionally indicate expected performance-quality tradeoffs for one or more prospective setting adjustments.

In Example 10, the feature control information of Example 9 may optionally indicate a quality change for each of the one or more prospective setting adjustments, the quality change determined according to a quality function.

In Example 11, the at least one machine-readable medium of Example 10 may optionally store instructions that, in response to being executed on the computing device, cause the computing device to: obtain user feedback during a quality calibration sequence; determine one or more component quality values based on the user feedback; and determine the quality function based on the component quality values.

In Example 12, the at least one machine-readable medium of any one of Examples 1 to 11 may optionally store instructions that, in response to being executed on the computing device, cause the computing device to: generate performance information at one or more of a processor circuit, a memory unit, a power control unit (PCU), and a graphics processing unit (GPU); and determine the performance metric based on the performance information.

In Example 13, the at least one machine-readable medium of any one of Examples 1 to 12 may optionally store instructions that, in response to being executed on the computing device, cause the computing device to: determine a quality metric during execution of the 3D graphics application; compare the quality metric to a quality threshold; and when the quality metric is less than the quality threshold, determine a third set of one or more setting adjustments based on the feature control information to increase a quality of the 3D graphics application.

In Example 14, the set of one or more setting adjustments of any one of Examples 1 to 13 may optionally comprise an adjustment to an anti-aliasing setting.

In Example 15, the set of one or more setting adjustments of any one of Examples 1 to 14 may optionally comprise an adjustment to an anisotropic filtering setting.

In Example 16, the set of one or more setting adjustments of any one of Examples 1 to 15 may optionally comprise an adjustment to a display resolution setting.

Example 17 is a graphics processing apparatus, comprising: a processor circuit to execute a 3D graphics application based on one or more feature control settings; and a 3D graphics management module to determine a performance metric during execution of the 3D graphics application, compare the performance metric to a performance threshold, and when the performance metric is less than the performance threshold, determine a set of one or more setting adjustments based on feature control information to increase a performance of the 3D graphics application.

In Example 18, the 3D graphics management module of Example 17 may optionally determine performance constraint information and determine the one or more setting adjustments based on the feature control information and the performance constraint information.

In Example 19, the performance constraint information of Example 18 may optionally identify one or more components that comprise performance bottlenecks in a graphics processing system.

In Example 20, the 3D graphics management module of any one of Examples 1 to 3 may optionally compare the performance metric to a second performance threshold, and when the performance metric is greater than the second performance threshold, determine a second set of one or more setting adjustments based on the feature control information to increase a quality of 3D graphics information generated by the 3D graphics application.

In Example 21, the performance metric of any one of Examples 17 to 20 may optionally comprise a frame rate of video generated by the 3D graphics application.

In Example 22, the 3D graphics management module of any one of Examples 17 to 21 may optionally adjust the one or more feature control settings during execution of the 3D graphics application based on the set of one or more setting adjustments.

In Example 23, the 3D graphics management module of Example 22 may optionally determine a second performance metric after adjusting the one or more feature control settings, and update the feature control information based on the second performance metric.

In Example 24, the 3D graphics management module of Example 23 may optionally wait for a delay period after adjusting the one or more feature control settings before determining the second performance metric.

In Example 25, the feature control information of any one of Examples 17 to 24 may optionally indicate expected performance-quality tradeoffs for one or more prospective setting adjustments.

In Example 26, the feature control information of Example 25 may optionally indicate a quality change for each of the one or more prospective setting adjustments, the quality change determined according to a quality function.

In Example 27, the 3D graphics management module of Example 26 may optionally obtain user feedback during a quality calibration sequence, determine one or more component quality values based on the user feedback, and determine the quality function based on the component quality values.

In Example 28, the 3D graphics management module of any one of Examples 17 to 27 may optionally determine the performance metric based on performance information generated at one or more of the processor circuit, a memory unit, a power control unit (PCU), and a graphics processing unit (GPU).

In Example 29, the 3D graphics management module of any one of Examples 17 to 28 may optionally determine a quality metric during execution of the 3D graphics application, compare the quality metric to a quality threshold, and when the quality metric is less than the quality threshold, determine a third set of one or more setting adjustments based on the feature control information to increase a quality of the 3D graphics application.

In Example 30, the set of one or more setting adjustments of any one of Examples 17 to 29 may optionally comprise an adjustment to an anti-aliasing setting.

In Example 31, the set of one or more setting adjustments of any one of Examples 17 to 30 may optionally comprise an adjustment to an anisotropic filtering setting.

In Example 32, the set of one or more setting adjustments of any one of Examples 17 to 31 may optionally comprise an adjustment to a display resolution setting.

Example 33 is a graphics processing device, comprising an apparatus according to any one of Examples 17 to 32, coupled to a transceiver operative to transmit 3D graphics information to a display.

Example 34 is a graphics processing method, comprising: commencing execution, by a processor circuit, of a three-dimensional (3D) graphics application based on one or more feature control settings; determining a performance metric during execution of the 3D graphics application; comparing the performance metric to a performance threshold; and when the performance metric is less than the performance threshold, determining a set of one or more setting adjustments based on feature control information to increase a performance of the 3D graphics application.

In Example 35, the graphics processing method of Example 34 may optionally comprise: determining performance constraint information; and determining the one or more setting adjustments based on the feature control information and the performance constraint information.

In Example 36, the performance constraint information of Example 35 may optionally identify one or more components that comprise performance bottlenecks in a graphics processing system.

In Example 37, the graphics processing method of any one of Examples 34 to 36 may optionally comprise: comparing the performance metric to a second performance threshold; and when the performance metric is greater than the second performance threshold, determining a second set of one or more setting adjustments based on the feature control information to increase a quality of 3D graphics information generated by the 3D graphics application.

In Example 38, the performance metric of any one of Examples 34 to 37 may optionally comprise a frame rate of video generated by the 3D graphics application.

In Example 39, the graphics processing method of any one of Examples 34 to 38 may optionally comprise adjusting the one or more feature control settings during execution of the 3D graphics application based on the set of one or more setting adjustments.

In Example 40, the graphics processing method of Example 39 may optionally comprise: determining a second performance metric after adjusting the one or more feature control settings; and updating the feature control information based on the second performance metric.

In Example 41, the graphics processing method of Example 40 may optionally comprise waiting for a delay period after adjusting the one or more feature control settings before determining the second performance metric.

In Example 42, the feature control information of any one of Examples 34 to 41 may optionally indicate expected performance-quality tradeoffs for one or more prospective setting adjustments.

In Example 43, the feature control information of Example 42 may optionally indicate a quality change for each of the one or more prospective setting adjustments, the quality change determined according to a quality function.

In Example 44, the graphics processing method of Example 43 may optionally comprise: obtaining user feedback during a quality calibration sequence; determining one or more component quality values based on the user feedback; and determining the quality function based on the component quality values.

In Example 45, the graphics processing method of any one of Examples 34 to 44 may optionally comprise: generating performance information at one or more of the processor circuit, a memory unit, a power control unit (PCU), and a graphics processing unit (GPU); and determining the performance metric based on the performance information.

In Example 46, the graphics processing method of any one of Examples 34 to 45 may optionally comprise: determining a quality metric during execution of the 3D graphics application; comparing the quality metric to a quality threshold; and when the quality metric is less than the quality threshold, determining a third set of one or more setting adjustments based on the feature control information to increase a quality of the 3D graphics application.

In Example 47, the set of one or more setting adjustments of any one of Examples 34 to 46 may optionally comprise an adjustment to an anti-aliasing setting.

In Example 48, the set of one or more setting adjustments of any one of Examples 34 to 47 may optionally comprise an adjustment to an anisotropic filtering setting.

In Example 49, the set of one or more setting adjustments of any one of Examples 34 to 48 may optionally comprise an adjustment to a display resolution setting.

Example 50 is an apparatus, comprising means for performing a graphics processing method according to any one of Examples 34 to 49.

Example 51 is a communications device arranged to perform a graphics processing method according to any one of Examples 34 to 49.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. At least one machine-readable medium storing a set of instructions that, in response to being executed on a computing device, cause the computing device to:
execute a three-dimensional (3D) graphics application based on one or more feature control settings;
determine a performance metric during execution of the 3D graphics application;
compare the performance metric to a performance threshold; and
when the performance metric is less than the performance threshold, determine a set of one or more setting adjustments based on feature control information to increase a performance of the 3D graphics application.

2. The at least one machine-readable medium of claim 1, storing instructions that, in response to being executed on the computing device, cause the computing device to:
compare the performance metric to a second performance threshold; and
when the performance metric is greater than the second performance threshold, determine a second set of one or more setting adjustments based on the feature control information to increase a quality of 3D graphics information generated by the 3D graphics application.

3. The at least one machine-readable medium of claim 1, the performance metric comprising a frame rate of video generated by the 3D graphics application.

4. The at least one machine-readable medium of claim 1, storing instructions that, in response to being executed on the computing device, cause the computing device to adjust the one or more feature control settings during execution of the 3D graphics application based on the set of one or more setting adjustments.

5. The at least one machine-readable medium of claim 4, storing instructions that, in response to being executed on the computing device, cause the computing device to:
determine a second performance metric after adjusting the one or more feature control settings; and
update the feature control information based on the second performance metric.

6. The at least one machine-readable medium of claim 1, the feature control information indicating expected performance-quality tradeoffs for one or more prospective setting adjustments.

7. The at least one machine-readable medium of claim 6, the feature control information indicating a quality change for each of the one or more prospective setting adjustments, the quality change determined according to a quality function.

8. The at least one machine-readable medium of claim 1, storing instructions that, in response to being executed on the computing device, cause the computing device to:
generate performance information at one or more of a processor circuit, a memory unit, a power control unit (PCU), and a graphics processing unit (GPU); and
determine the performance metric based on the performance information.

9. An apparatus, comprising:
a processor circuit to execute a 3D graphics application based on one or more feature control settings; and
a 3D graphics management module to determine a performance metric during execution of the 3D graphics application, compare the performance metric to a performance threshold, and when the performance metric is less than the performance threshold, determine a set of one or more setting adjustments based on feature control information to increase a performance of the 3D graphics application.

10. The apparatus of claim 9, the 3D graphics management module to compare the performance metric to a second performance threshold, and when the performance metric is greater than the second performance threshold, determine a second set of one or more setting adjustments based on the feature control information to increase a quality of 3D graphics information generated by the 3D graphics application.

11. The apparatus of claim 9, the performance metric comprising a frame rate of video generated by the 3D graphics application.

12. The apparatus of claim 9, the 3D graphics management module to adjust the one or more feature control settings during execution of the 3D graphics application based on the set of one or more setting adjustments.

13. The apparatus of claim 12, the 3D graphics management module to determine a second performance metric after adjusting the one or more feature control settings, and update the feature control information based on the second performance metric.

14. The apparatus of claim 9, the feature control information indicating expected performance-quality tradeoffs for one or more prospective setting adjustments.

15. The apparatus of claim 14, the feature control information indicating a quality change for each of the one or more prospective setting adjustments, the quality change determined according to a quality function.

16. The apparatus of claim 9, the 3D graphics management module to determine the performance metric based on performance information generated at one or more of the processor circuit, a memory unit, a power control unit (PCU), and a graphics processing unit (GPU).

17. A device, comprising:
an apparatus according to claim 9 coupled to a transceiver operative to transmit 3D graphics information to a display.

18. A method, comprising:
executing, by a processor circuit, a three-dimensional (3D) graphics application based on one or more feature control settings;
determining a performance metric during execution of the 3D graphics application;
comparing the performance metric to a performance threshold; and
when the performance metric is less than the performance threshold, determining a set of one or more setting adjustments based on feature control information to increase a performance of the 3D graphics application.

19. The method of claim 18, comprising:
comparing the performance metric to a second performance threshold; and
when the performance metric is greater than the second performance threshold, determining a second set of one or more setting adjustments based on the feature control information to increase a quality of 3D graphics information generated by the 3D graphics application.

20. The method of claim 18, the performance metric comprising a frame rate of video generated by the 3D graphics application.

21. The method of claim 18, comprising adjusting the one or more feature control settings during execution of the 3D graphics application based on the set of one or more setting adjustments.

22. The method of claim 21, comprising:
determining a second performance metric after adjusting the one or more feature control settings; and
updating the feature control information based on the second performance metric.

23. The method of claim 18, the feature control information indicating expected performance-quality tradeoffs for one or more prospective setting adjustments.

24. The method of claim 23, the feature control information indicating a quality change for each of the one or more prospective setting adjustments, the quality change determined according to a quality function.

25. The method of claim 18, comprising:
generating performance information at one or more of the processor circuit, a memory unit, a power control unit (PCU), and a graphics processing unit (GPU); and
determining the performance metric based on the performance information.
